(19) United States
(12) Patent Application Publication
(10) Pub. No.: US 2015/0095556 A1
(43) Pub. Date: Apr. 2, 2015

(54) MEMORY SYSTEM

(71) Applicant: KABUSHIKI KAISHA TOSHIBA, Tokyo (JP)

(72) Inventors: Hiroyuki GOTO, Kanagawa (JP); Shinya TAKEDA, Kanagawa (JP); Akihito TOUHATA, Kanagawa (JP)

(73) Assignee: KABUSHIKI KAISHA TOSHIBA, Tokyo (JP)

(21) Appl. No.: 14/195,765

(22) Filed: Mar. 3, 2014

(30) Foreign Application Priority Data
Sep. 30, 2013 (JP) 2013-205886

(51) Int. Cl. G06F 12/02

(52) U.S. Cl. CPC G06F 12/0246; G06F 2212/7208
USPC 711/103

(57) ABSTRACT

A memory system includes a first memory chip, a second memory chip, and a memory controller. The first memory chip and the second memory chip are connected to the memory controller via a plurality of data lines including a first data line and a second data line. The first memory chip is configured to outputs status information via the first data line to the memory controller. The second memory chip is configured to output status information via the second data line to the memory controller at the same time as the first memory chip.

### CROSS-REFERENCE TO RELATED APPLICATION

This application is based upon and claims the benefit of priority from Japanese Patent Application No. 2013-205886, filed Sep. 30, 2013, the entire contents of which are incorporated herein by reference.

### FIELD

Embodiments described herein relate generally to a memory system.

### BACKGROUND

The demand for memory systems using NAND-type flash memory, or similar solid-state components, is rapidly increasing along with the increasing prevalence of imaging and streaming video applications in a mobile apparatus, such as a smart phone, a tablet device or the like. These types of applications require the processing and transfer of large volumes of data at a high speed.

### DESCRIPTION OF THE DRAWINGS

FIG. 1 is a diagram illustrating connections between semiconductor chips and a memory controller of a memory system according to a first embodiment.

FIG. 2 is a block diagram illustrating a memory controller of the memory system according to the first embodiment.

FIG. 3 is a block diagram illustrating a semiconductor chip of the memory system according to the first embodiment.

FIG. 4 depicts a flow of operations of the memory system according to the first embodiment.

FIG. 5 is a timing chart of a first operation in the memory system according to the first embodiment.

FIG. 6 is a timing chart of a second operation in the memory system according to the first embodiment.

FIG. 7 is a diagram illustrating connections between semiconductor chips and a memory controller of a memory system according to a second embodiment.

FIG. 8 depicts example status information output by respective semiconductor chips C1 to C4 and corresponding data buses I/O(0) to I/O(7).

FIG. 9 depicts a flow of operations of the semiconductor chip and the memory controller of the memory system according to the second embodiment.

FIG. 10 is a timing chart of a first operation in the memory system according to the second embodiment.

FIG. 11 is a timing chart of a second operation in the memory system according to the second embodiment.

### DETAILED DESCRIPTION

An embodiment of the present disclosure provides a memory system capable of processing data at a high speed.

In general, according to one embodiment, a memory system includes a first semiconductor chip, a second semiconductor chip, and a memory controller. The first semiconductor chip and the second semiconductor chip are connected in common to the memory controller via a plurality of I/O lines (data lines) including a first I/O line (first data line) and a second I/O line (second data line). While the first semiconductor chip outputs status information of the first semiconductor chip via the first I/O line to the memory controller, the second semiconductor chip also outputs status information of the second semiconductor chip via the second I/O line to the memory controller. That is, the first and second semiconductor chips are configured to output respective status information to the memory controller at a same time. As used herein, each “semiconductor chip” may include a memory chip or a plurality of memory chips. A plurality of memory chips on a semiconductor chip may be disposed in any possible arrangement including a stacked arrangement.

### First Embodiment

### 1. Overall Configuration of Memory System

A memory system according to one or more exemplary embodiments of the present disclosure will be described with reference to the drawings. In the drawings, a common reference numeral may be used to indicate a same (or substantially similar) component depicted in multiple drawings.

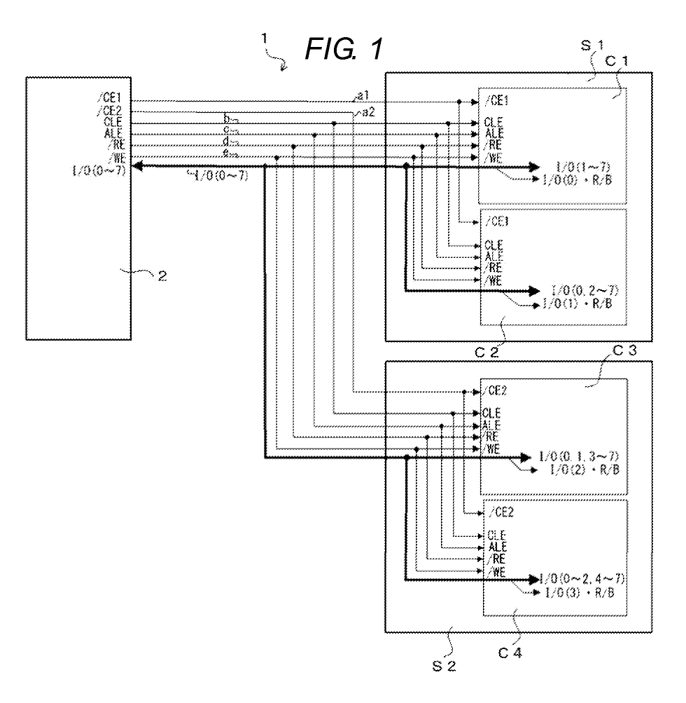

FIG. 1 is a diagram illustrating connections between semiconductor chips C1 to C4 and a memory controller 2 of the memory system 1 according to a first embodiment. Exemplary connections between the memory controller 2 and chip stacks S1 and S2 of the memory system 1 according to the first embodiment are illustrated. In some embodiments, there may be additional connections or fewer connections than those depicted in FIG. 1. As illustrated in FIG. 1, the memory system 1 includes the memory controller 2 and the chip stacks S1 and S2. The memory controller 2 controls operations of a plurality of chip stacks. The number of chip stacks included in the memory system 1 is not limited to two and the number may be less than two or greater than two.

The memory controller 2 is connected to the chip stack S1 via a signal line a1. Additionally, chip stack S1 is connected to memory controller 2 via signal lines b-e and several (e.g., eight) Input/Output (I/O) signal lines. The I/O signal lines in this example embodiment consist of eight lines numbered 0 to 7. Each chip in chip stack S1 is connected to the memory controller 2 via signal line a1, signal lines b-e, and the I/O signal lines. As depicted in FIG. 1, the various signal lines between chip stack S1 and memory controller 2 may be branched to each chip (e.g., C1 and C2) in chip stack S1 by branching connections located on chip stack S1 rather than each chip having a separate connection(s).

The memory controller 2 is connected to chip stack S2 via a signal line a2. The signal lines a1 and a2 transmit a chip selection signal. In a manner similar to chip stack S1, chip stack S2 is connected to memory controller via signal lines b-e and the I/O signal lines. In this manner, the memory controller 2 is connected in to each semiconductor chip in the chip stacks (e.g., C1, C2, C3, and C4) via the signal line b (a first control data bus), the signal line c (a second control data bus), the signal line d (a third control data bus), and the signal line e (a fourth control data bus). Furthermore, the memory controller 2 is connected to the semiconductor chips C1 to C4 via data buses I/O(0) to I/O(7) (I/O lines).

The signal line b transmits a signal ALE (address latch enable), the signal line c transmits a signal CLE (command latch enable), the signal line d transmits a signal /WE (write enable), and the signal line e transmits a signal /RE (read enable).

Note that, in the following description, the semiconductor chips C1 to C4 may be referred to as a semiconductor chip C when it is not required to differentiate the semiconductor chips C1 to C4 from each other.

A command, an address, and data are transmitted from the memory controller 2 to semiconductor chip C via the data buses I/O(0) to I/O(7). In addition, data and status information are transmitted from semiconductor chip C to the memory controller 2 via the data buses I/O(0) to I/O(7).

The signal /WE is a signal for indicating data from the data buses I/O(0) to I/O(7) should be latched into the semiconductor chip C. The signal /RE is a signal indicating data should be read from the semiconductor chip C and output on the data buses I/O(0) to I/O(7).

The signal ALE is a signal for inputting an address to the semiconductor chip C. While the signal ALE is asserted (that is, at level indicating address latching is to be enabled), the semiconductor chip C recognizes a signal from the data buses I/O(0) to I/O(7) as an address.

The signal CLE is a signal for inputting a command (for example, a writing command) to the semiconductor chip C. While CLE is asserted, the semiconductor chip C recognizes a signal from the data buses I/O(0) to I/O(7) as a command.

The semiconductor chip C recognizes a signal from the data buses I/O(0) to I/O(7) as data when neither of ALE or CLE is asserted. In this manner the signals ALE and CLE are used to cause the semiconductor chip C to recognize a signal which is input from the data buses I/O(0) to I/O(7) as a command, an address, or data.

In a write operation to the semiconductor chip C, the memory controller 2 inputs a writing command to the semiconductor chip C by asserting the signal CLE while the signal ALE is not asserted (that is, negated).

The memory controller 2 inputs an address to the semiconductor chip C by asserting the signal ALE while the signal CLE is not asserted (negated).

Further, the memory controller 2 inputs data to the semiconductor chip C by negating both of ALE and CLE. In response to the signal /WE (the write command), data from the I/O lines is written to an address of a memory cell (or memory cells) in the semiconductor chip C.

In a read operation C, the memory controller 2 inputs a reading command (signal /RE) to the semiconductor chip C while asserting the signal CLE when the signal ALE is not asserted. In addition, the memory controller 2 inputs an address to the semiconductor chip C while asserting the signal ALE when the signal CLE is not asserted. Further, the semiconductor chip C reads data from a memory cell designated by the address, and outputs the data to the memory controller 2 in response to the signal /RE.

### 2. Configuration of Memory Controller

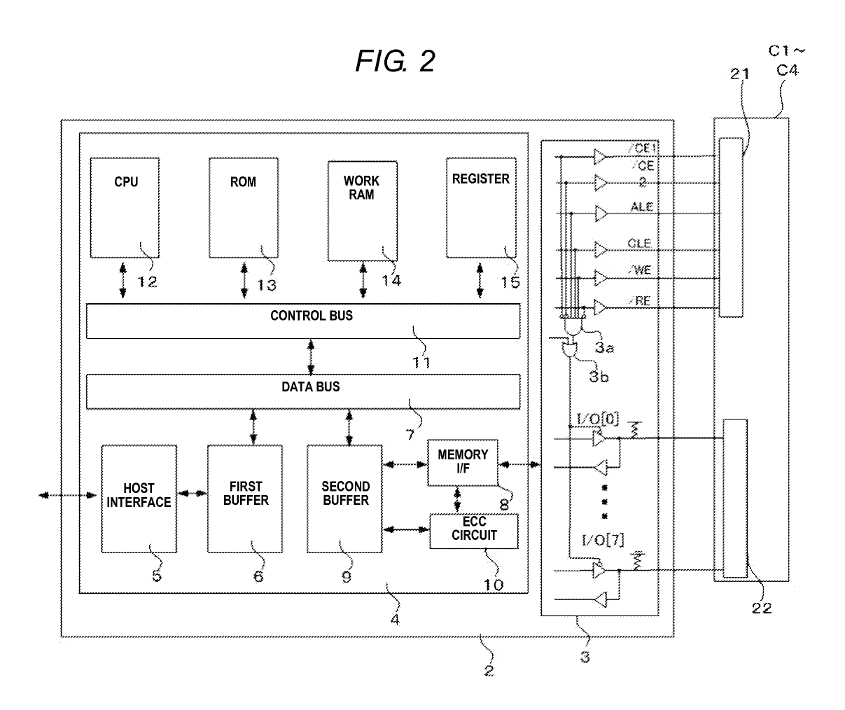

FIG. 2 is a block diagram illustrating a possible configuration of the memory controller 2 of the memory system 1 according to the first embodiment. As illustrated in FIG. 2, the memory controller 2 includes an input and output circuit 3, and a core logic unit 4. The input and output circuit 3 includes hardware components for connecting the memory system 1 to a host controller (not specifically depicted). The memory system 1 is configured to communicate with the host (not specifically depicted). The memory system 1 and the host communicate with each other in a protocol in which the memory system 1 may designate a size and a position of a data part to be written for at least a writing request from the host.

The input and output circuit 3 includes a hardware configuration for connecting the memory controller 2 to the semiconductor chips C1 to C4. The core logic unit 4 includes a host interface (host I/F) 5, a first buffer 6, a data bus 7, a memory interface (memory I/F) 8, a second buffer 9, an ECC circuit 10, a control bus 11, a CPU 12, a ROM 13, a work RAM 14, and a register 15.

The input and output circuit 3 is connected to the host interface 5 and a data input and output circuit 21 of each of the semiconductor chips C1 to C4. In addition, the input and output circuit 3 has a first AND circuit 3a, and an OR circuit 3b connected to the data buses I/O(0) to I/O(7). The memory interface 8 outputs a signal to input and output buffers of the data buses I/O(0) to I/O(7) in the input and output circuit 3 (hereinafter called “I/O cell”) via the first AND circuit 3a and the OR circuit 3b when a specific signal (an operation start signal) described later is output from the input and output circuit 3, thereby controlling each of the data buses I/O(0) to I/O(7).

Further, a control signal from the memory interface 8 is input to the OR circuit 3b along with an output signal from the first AND circuit 3a. This control signal is set to an H (high) level, and thus the I/O cell may be made to enter an input state regardless of an output signal from the first AND circuit 3a.

The host interface 5 performs a process which is required for the memory system 1 to communicate with the host. More specifically, the host interface 5 performs communication between the memory system 1 and the host in conformity to a communication protocol to which both of the memory system 1 and the host conform.

The first buffer 6 temporarily holds data which is output from the memory system 1 to the host via the host interface 5. The first buffer 6 is connected to the data bus 7.

The memory interface 8 is connected to the input and output circuit 3. The memory interface 8 performs a process which is required for the memory controller 2 to communicate with the semiconductor chips C1 to C4. The memory interface 8 outputs an instruction from the core logic unit 4 to the input and output circuit 3 in a form in which the semiconductor chips C1 to C4 may recognize the instruction.

The second buffer 9 is connected to the memory interface 8. The second buffer 9 temporarily holds data which is scheduled to be output to the semiconductor chips C1 to C4 from the memory controller 2. The second buffer 9 is connected to the data bus 7. The memory interface 8 and the second buffer 9 are connected to the ECC circuit 10.

The ECC circuit 10 is also connected to the second buffer 9. The ECC circuit 10 receives data to be written from the host via the data bus 7, adds an error correction code to the data to be written, and supplies the data to be written to which the error correction code has been added, to the second buffer 9.

The control bus 11 is connected to the CPU 12, the ROM 13, the RAM 14, and the register 15. The CPU 12, the ROM 13, the RAM 14, and the register 15 communicate with each other via the control bus 11. The CPU 12 controls operation of the overall memory system 1. The CPU 12 executes a predetermined process according to a control program (command) stored in the ROM 13. The CPU 12 executes a predetermined process on the semiconductor chips C1 to C4 in response to a command received from the host according to the control program.

The ROM 13 stores a control program and the like executed by the CPU 12. The RAM 14 is used as a work area of the CPU 12, and temporarily stores variables or the like necessary for work of the CPU 12. The register 15 holds various values necessary for operations of the memory system 1. In addition, the register 15 holds various values which are required for the memory controller 2 to control the memory system 1.

The data bus 7 is connected to the host interface 5, the first buffer 6, the memory interface 8, and the second buffer 9. The CPU 12 controls the host interface 5, the first buffer 6, the memory interface 8, and the second buffer 9 on the basis of a control program or an instruction from the host.

### 3. Configuration of Chip Stack

As illustrated in FIG. 1, the first and second chip stacks S1 and S2 have a stack structure in which the semiconductor chips C1 and C2 and the semiconductor chips C3 and C4 are respectively stacked. The chip stacks S1 and S2 are, for example, NAND flash memories. In addition, the number of stacked semiconductor chips is not limited to two, and may be smaller than two or larger than two.

### 4. Configuration of Semiconductor Chip

The semiconductor chips (e.g., C1 to C4) perform writing and reading of data in a specific writing unit formed by a plurality of bits. In addition, the semiconductor chips erase data in an erasure unit formed by a plurality of writing units.

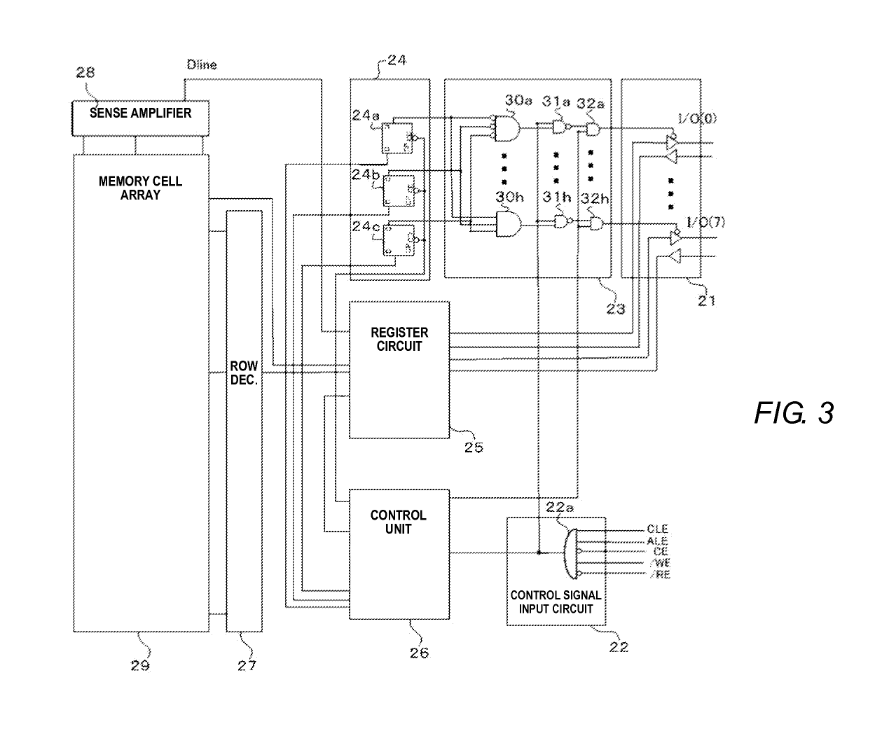

FIG. 3 is a block diagram depicting a configuration of the semiconductor chips C1 to C4. As illustrated in FIG. 3, each semiconductor chip includes a data input and output circuit 21, a control signal input circuit 22, an I/O selection circuit 23, a chip identification circuit 24, a register circuit 25, a control unit 26, a row decoder 27, a sense amplifier 28, and a memory cell array 29.

The data input and output circuit 21 controls input and output of a signal to and from each of the data buses I/O(0) to I/O(7). The data input and output circuit 21 outputs predetermined data on the basis of an instruction of each control signal from the memory controller 2. When data read from the memory cell array 29 is output to the memory controller 2, the data input and output circuit 21 receives data amplified by the sense amplifier 28 via the register circuit 25, and then outputs the data to the host via the data buses I/O(0) to I/O(7) and the memory controller 2.

The control signal input circuit 22 receives control signals (CLE, ALE, /CE1 to /CE4, /WE, and /RE) which are output from the memory controller 2, and outputs the control signals to the control unit 26. It is assumed that respective signal lines a1 (/CE1), a2 (/CE2), d (/WE) and e (/RE) are set to an low potential level (L level) when indicating the corresponding command has been asserted. The control signal input circuit 22 has a second AND circuit 22a, and is connected to fourth AND circuits 31a to 31h and the control unit 26 via the second AND circuit 22a.

When a status is output, the I/O selection circuit 23 selects the data buses I/O(0) to I/O(7) to which the status is to be output based on information from the chip identification circuit 24. The I/O selection circuit 23 includes third AND circuits 30a to 30h, the fourth AND circuits 31a to 31h, and fifth AND circuits 32a to 32h.

The third AND circuits 30a to 30h are asserted when identification information corresponding to the respective semiconductor chips C1 to C4 is received.

The respective fourth AND circuits 31a to 31h are asserted when receiving signals from the third AND circuits 30a to 30h and a signal from the AND circuit of the control signal input circuit 22. The fourth AND circuits 31a to 31h are respectively connected to the third AND circuits 30a to 30h as input sources of signals.

The fifth AND circuits 32a to 32h are respectively connected to the fourth AND circuits 31a to 31h and the control unit 26 as input sources of signals. In addition, the fifth AND circuits 32a to 32h are connected to the data buses I/O(0) to I/O(7) as output destinations of signals.

The chip identification circuit 24 holds identification information for identifying a chip, and serves to identify other chips from the chip in which the chip identification circuit 24 is itself located. The chip identification circuit 24 includes first to third flip-flop circuits 24a to 24c each of which has 1-bit information of “1” or “0”. In other words, the chip identification information is formed by a combination of “1” or “0” stored in the first to third flip-flop circuits 24a to 24c. The first to third flip-flop circuits 24a to 24c may hold 3-bits of information in total, and holds different identification information for each of the semiconductor chips C1 to C4. For example, in relation to the semiconductor chip C1, the first flip-flop circuit 24a holds “0”, the second flip-flop circuit 24b holds “0”, and the third flip-flop circuit 24c holds “0”. Similarly, in relation to the semiconductor chips C2 to C4, identification information held by the first to third flip-flop circuits 24a to 24c may be, for example, “1, 0, 0”, “0, 1, 0”, and “0, 0, 1” (“information of the first flip-flop circuit, information of the second flip-flop circuit, and information of the third flip-flop circuit”). In addition, in relation to the respective semiconductor chips C1 to C4, information held by the first to third flip-flop circuits 24a to 24c may be information formed by combinations other than “1” and “0”, or may be “1, 1, 0”, “1, 0, 1”, “1, 1, 0”, and “1, 1, 1”.

The register circuit 25 is electrically connected to the control unit 26. The register circuit 25 functions as a data register, a status register holding status information of the semiconductor chips C1 to C4, an address register holding address information, and a block, a page and a plane of the memory cell array 29, and a command register holding a command which is output from the memory controller 2. When a command is received from the control unit 26, the register circuit 25 inputs and outputs data to and from the sense amplifier 28 via a data line Dline. In addition, the register circuit 25 may transfer address information supplied from the memory controller 2, to the control unit 26.

The control unit 26 controls an operation of, for example, a NAND type flash memory. In other words, an operation sequence in a write operation, a read operation, and an erasure operation of data is executed based on the above-described address and command given from the memory controller 2 via the data input and output circuit 21. When the control unit 26 performs a write operation, a read operation, or an erasure operation, status information for setting a status in the register circuit 25 is information indicating a status of the respective semiconductor chip C1 to C4 in which the register 25 is located. For example, when a write operation finishes, “Ready” is set as status information, and, during a write operation, “Busy” is set as status information. “Ready” indicates a status in which the semiconductor chip may receive the next command, and “Busy” indicates a state in which the semiconductor chip is not ready to receive the next command.

The memory cell array 29 includes a plurality of memory cells. The control unit 26 selects a memory cell by using a word line selected by the row decoder 27. In addition, the control unit 26 outputs data in a selected memory cell to the data input and output circuit 21 via a bit line. The data is amplified in the sense amplifier 28, and is then output to the data buses I/O(0) to I/O(7) via the data line Dline, the register circuit 25, and the data input and output circuit 21.

For convenience of description, a single semiconductor chip C is described as an example in FIG. 3. The respective semiconductor chips C1 to C4 have the same configuration, and thus detailed description of each semiconductor chips C1 to C4 can be omitted.

### 5. Operation of Memory System According to First Embodiment

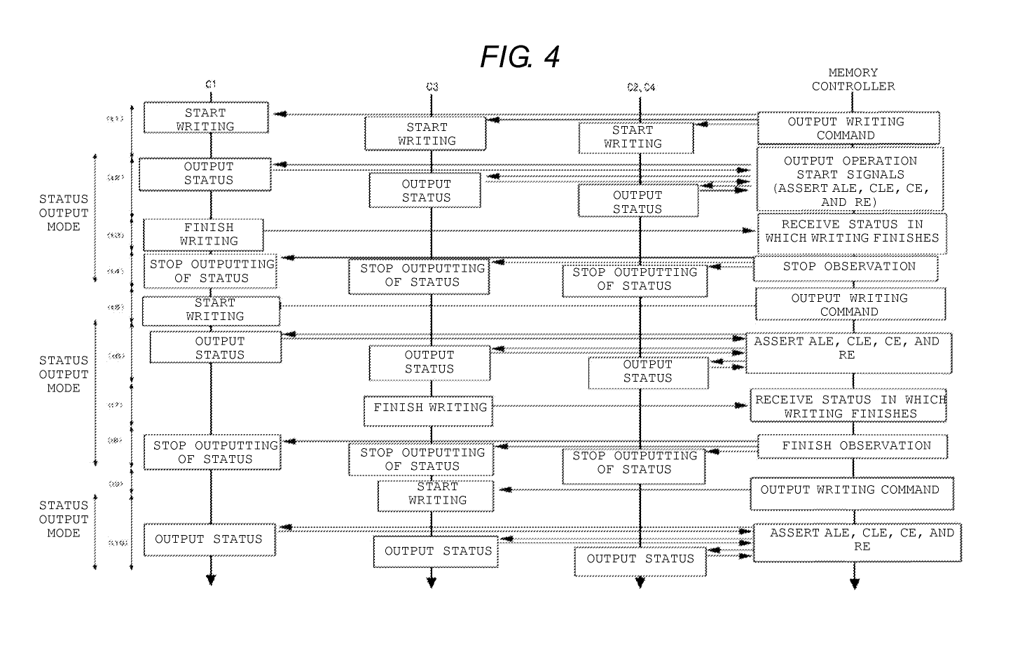

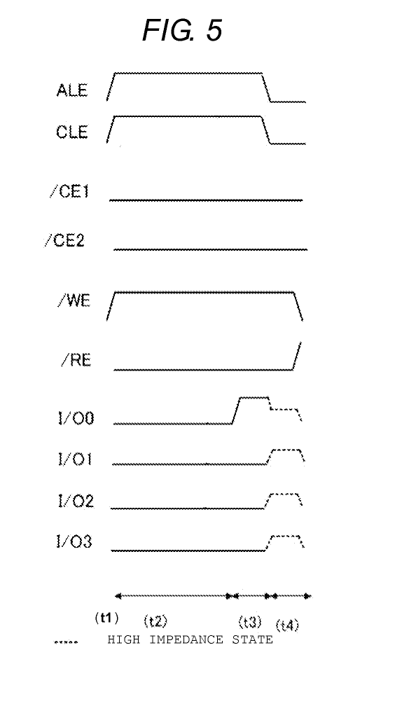

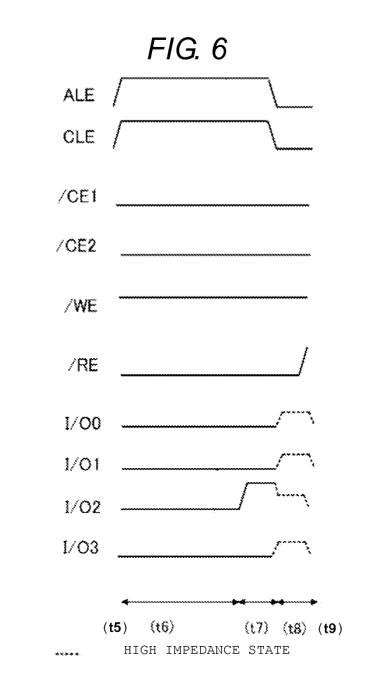

Next, an operation of the memory system 1 will be described with reference to FIGS. 4 and 5. An operation of the memory system 1 includes, for example, a write operation to the semiconductor chips C1 to C4 and a read operation of a status by the controller. FIG. 4 is a diagram illustrating a flow of operations of the semiconductor chips C1 to C4 and the memory controller 2. FIGS. 5 and 6 are timing charts illustrating that first operation start signals are input and a status command is input in the memory system 1 according to the first embodiment.

As illustrated in FIG. 4, the memory controller 2 outputs a writing command to the semiconductor chip C1 (at time t1 before time t2). At this time, the memory controller 2 outputs, for example, a chip enable signal /CE1 on the signal line a1, and sets a low level (“L level”) thereon so as to assert the signal. Accordingly, the memory controller 2 selects the chip stack S1. The memory controller 2 also outputs a writing command on the data buses I/O(0) to I/O(7) to the semiconductor chip C1. The semiconductor chip C2 is unselected through a designation using a writing address. The memory controller 2 may sequentially select the semiconductor chips C3 and C4 in a similar manner, and the output the writing command thereto at time t1.

Next, the memory controller 2 outputs a control signal to each of the semiconductor chips C1 to C4 (at time t2). At this time, as illustrated in FIG. 4, the memory controller 2 sets signals CLE and ALE to a high level (“an H level”), and sets control signals /CE1, /CE2, and /RE to an L level, so as to assert the control signals /CE1, /CE2, and /RE, and sets signal /WE to an H level so as to negate the control signal /WE. A combination of these signals is assumed to be first operation start signals.

As described above, signals ALE and CLE are control signals for causing the semiconductor chip to recognize that a signal input from the data buses I/O(0) to I/O(7) corresponds to one of a command, an address, and data. Therefore, for input operations of a command, an address, and data, the signals ALE and CLE are not asserted at the same time. In addition, the signals ALE and CLE are signals based on the premise that a signal will be input to the semiconductor chip C from the data buses I/O(0) to I/O(7). Thus, signal /RE is not asserted and the signal /WE is not negated in a state in which either the signal ALE or the signal CLE is asserted. In other words, the first operation start signals are assumed to include a combination of control signals which are not used when a writing command or a status command is output or when memory data is input and output.

In addition, the memory system 1 according to the present embodiment asserts the signals CLE, ALE, /CE, and /RE so as to output the first operation start signals to the semiconductor chips C1 to C4, but the first operation start signals may be signals including other combinations in which each of the control signals CLE, ALE, /CE, /RE and /WE is asserted or negated as long as the combinations are formed by signals not used for issuing a writing command and a status command to the semiconductor chip C and for data input and output operations. For example, any of the combinations of the following control signals may be the first operation start signals. Further, any combination obtained by adding other control signals to the communications exemplified below may be the first operation start signals.

(1) ALE is asserted, and CLE is asserted.

(2) CLE is asserted, and /RE is asserted.

(3) ALE is asserted, and /RE is asserted.

(4) /RE is asserted, and /WE is asserted.

The AND circuit 3a of the input and output circuit 3 of the memory controller 2 outputs a signal with an H level to the OR circuit 3b, and the OR circuit 3b outputs a signal with an H level to the I/O Cell to send the first operation start signals to the semiconductor chips C1 to C4. Accordingly, the input and output buffer of each of the data buses I/O(0) to I/O(7) is turned to an inactive state, and status information may be received from the data buses I/O(0) to I/O(7) via the input and output buffers.

The semiconductor chips C1 to C4 receive the first operation start signals, and output the signals to the second AND circuit 22a of the control signal input circuit 22. The second AND circuit 22a outputs the signals to the fourth AND circuits 31a to 31h of the I/O selection circuit 23.

During the operation of the present embodiment, the chip identification circuit 24 outputs a chip identification signal to the I/O selection circuit 23. Signals from the flip-flop circuits 24a to 24c of the chip identification circuit 24 are inverted (or are not inverted) and are input to the third AND circuits 30a to 30h. Combinations of inversion and non-inversion are different from each other in the third AND circuits 30a to 30h, and a combination of inversion and non-inversion unique to each of the third AND circuits 30a to 30h is assigned thereto. Accordingly, the third AND circuit corresponding to identification information is selected among the third AND circuits 30a to 30h.

For convenience of description, the semiconductor chip C1 is selected as an example of a selection of a semiconductor chip C. The first to third flip-flop circuits 24a to 24c of the semiconductor chip C1 holds, for example, identification information “0, 0, 0”. Therefore, among the third AND circuits 30a to 30h, only the third AND circuit 30a outputs a signal with an H level. The third AND circuit 30a is a third AND circuit selected so as to correspond to the identification information.

At this time, the second AND circuit 22a also outputs a signal with an H level to the fourth AND circuits 31a to 31h. For this reason, the fourth AND circuit 31a outputs a signal with an L level to the fifth AND circuit 32a, and the fifth AND circuit 32a outputs a signal with an L level to the output buffer of the data bus I/O(0). Thus, the output buffer of the data bus I/O(0) is activated.

On the other hand, the unselected third AND circuits 30b to 30h output signals with an L level, and the fourth AND circuits 31b to 31h output signals with an H level to the fifth AND circuit 32a. In addition, the fifth AND circuit 32a outputs a signal with an H level to the output buffers of the data buses I/O(1) to I/O(7) such that the data buses I/O(1) to I/O(7) are inactivated. As a result, only the output buffer of the data bus I/O(0) is activated, and thus the data bus I/O(0) is selected.

Although the semiconductor chip C1 is exemplified here, selection operations of the semiconductor chips C2 to C4 are similar in manner to the operation of the semiconductor chip C1 though, in accordance with respective pieces of identification information, the data bus I/O(1) is selected in the semiconductor chip C2, the data bus I/O(2) is selected in the semiconductor chip C3, and the data bus I/O(3) is selected in the semiconductor chip C4.

The control unit 26 controls the register circuit 25 to output status information on the selected data buses I/O(0) to I/O(7) (t2).

When the memory controller 2 outputs the first operation start signals, each of the semiconductor chips C1 to C4 outputs status information of Ready or Busy on the designated data buses I/O(0) to I/O(7) (t2). A state in which the semiconductor chips C1 to C4 output status information corresponds to a status during a write operation performed on the basis of an instruction of the operation start signals is referred to as a “status output mode.”

In addition, each of the semiconductor chips C1 to C4 outputs status information to an assigned data bus of the data buses I/O(0) to I/O(7) during the status output mode, but may input a signal with an L level from the control unit 26 to the fifth AND circuits 32a to 32h in a read operation of data so that all of the data buses I/O(0) to I/O(7) are selected, thereby outputting data.

Next, when the write operation in the semiconductor chip C1 finishes, a Ready signal is output on the data bus I/O(0) (at time t3).

The memory controller 2 sets signals ALE and CLE to an L level so as to negate each signal on the basis of the status information from the semiconductor chips C1 to C4 (at time t4). Accordingly, the status output mode stops.

The memory controller 2 sets the data buses I/O(0) to I/O(7) to a high impedance state when the status output mode stops (at time t4). The high impedance state is a state in which no signal is output from the semiconductor chips or from the memory controller 2. Accordingly, data which is output from the memory controller 2 may be prevented from colliding (interfering) with data and statuses which are output from the semiconductor chips C1 to C4 on the data buses I/O(0) to I/O(7).

As depicted in FIG. 6, the memory controller 2 selects again the semiconductor chip C1 which has finished the previous write operation, and outputs a writing command thereto (at time t5). At this time, the memory controller 2 selects the semiconductor chip C1, and does not select the semiconductor chips C3 and C4.

Next, as illustrated in FIG. 6, the memory controller 2 sets signals ALE and CLE to an H level, so as to assert various signals indicating a start of the status output mode. Accordingly, the semiconductor chips C1 to C4 transition to a status output mode again, and status information is supplied by the designated data buses I/O(0) to I/O(7) during a write operation (at time t6).

When the write operation finishes, the semiconductor chip C3 outputs a signal with an H level, that is, a Ready signal on the data bus I/O(2) (at time t7).

When the Ready signal is input, the memory controller 2 sets output states of the data buses I/O(0) to I/O(7) to a high impedance state in the same manner as occurred at time t4, and stops communication between the semiconductor chips C1 to C4 and the memory controller 2 (at time t8). At this time, signal CLE is set to an L level, signal ALE is set to an L level, signal /CE1 is set to an H level, and signal /RE is set to an H level.

Subsequently, the memory controller 2 selects the semiconductor chip C3 again, and outputs a writing command thereto (at time t9). The semiconductor chips C1, C2 and C4 are not selected. The semiconductor chip C3 performs a write operation again on the basis of the supplied writing command.

Similarly to the process at time t3, when the memory controller 2 asserts each signal, each of the semiconductor chips C1 to C4 is turned to the status output mode again. Subsequently, the semiconductor chips C1 to C4 output a Ready or Busy signal to the memory controller 2 during the write operation (at time t10).

Next, the semiconductor chips C1 to C4 which finish the write operation are sequentially selected in the same manner, and outputting of the next command and reading of a status are repeatedly performed.

In the status output mode, the data buses I/O(4) to I/O(7) which are not assigned to the semiconductor chips C1 to C4 are set to a high impedance state.

In addition, although the semiconductor chips C1 to C4 are used in the present embodiment, five or more semiconductor chips may be used. For example, when the memory system 1 includes eight semiconductor chips (e.g., C1 to C8), the memory controller 2 assigns the respective semiconductor chips C1 to C8 to the data buses I/O(0) to I/O(7).

Effects of the memory system 1 according to the first embodiment will be described.

In the memory system 1 according to the first embodiment, the memory controller 2 outputs the first operation start signals, and thus the semiconductor chips C1 to C4 output status information of Ready or Busy on the respective designated data buses I/O(0) to I/O(7). Accordingly, the memory controller may observe the status information of the respective semiconductor chips C1 to C4 together. Since the memory controller 2 outputs the next command and signal as soon as one of the semiconductor chips C1 to C4 finishes an operation, the memory system 1 according to the present embodiment may reduce the waiting time required for the semiconductor chips C1 to C4 to receive the next command. In the above-described way, the memory system 1 may increase a data processing speed.

In addition, although the semiconductor chips C1 to C4 output status information in response to an instruction of the first operation start signals, the memory controller 2 is not required to output a signal for designating on which one of the data buses I/O(0) to I/O(7) a signal is to be output, and the time required for the memory controller 2 to output a signal or a status and the time required for the semiconductor chips C1 to C4 to input the signal or the status may be reduced, as compared with a case in which a controller must specifically output a status request command. In other words, the respective semiconductor chips C1 to C4 may be made to output status information just by asserting a specific combination of control signals together. Thus, when a status request command is to be output, a sequence, in which each of the signals ALE, CLE, /WE, /RE and /CE is set to an H level or an L level once or twice or more, is required to be output, and thus more time is taken than in the operation method of the memory system of the present embodiment.

The memory system 1 is only required to output a combination of the control signals ALE, CLE, /WE and /CE when the semiconductor chips C1 to C4 are in a status output mode, and a new control signal is not required to be provided. For this reason, terminals of the semiconductor chip C and the memory controller 2 for such new control signal are not required to be additionally provided.

When a Ready or Busy signal is output from the bus to which the semiconductor chips C1 to C4 are connected in common, there is a necessity that any one of the semiconductor chips C1 to C4 is selected and status information is confirmed individually. For this reason, time is required to confirm the status information. On the other hand, since the semiconductor chips C1 to C4 of the memory system 1 of the present embodiment simultaneously output status information by using assigned data buses among the data buses I/O(0) to I/O(7), the memory controller 2 may confirm the status information of the semiconductor chips simultaneously, and thus the overall time required for status confirmation is reduced.

In addition, when an independent bus is provided for each of the semiconductor chips C1 to C4 and a Ready or Busy signal is output, each bus for outputting the Ready or Busy signal is not only provided, but a terminal for connecting to the separately provided bus is also required. The semiconductor chips C1 to C4 according to the present embodiment output the Ready or Busy signal from the data buses I/O(0) to I/O(7), and thus a new bus and terminal is not required to be additionally provided.

### Second Embodiment

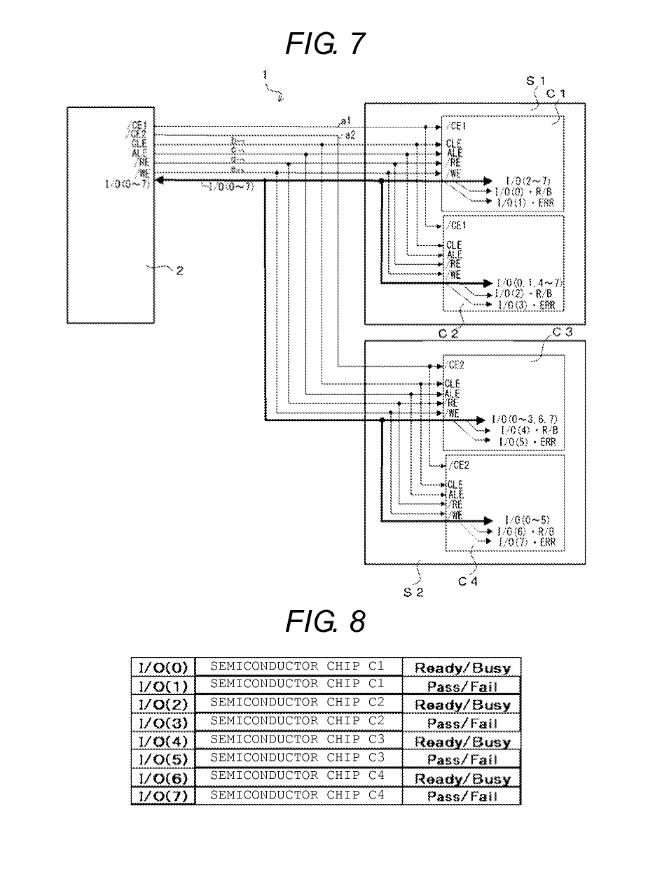

A memory system according to a second embodiment will be described. FIG. 7 is a diagram illustrating a connection example between the semiconductor chips C1 to C4 and the memory controller 2 of the memory system 1 according to the second embodiment. The semiconductor chips C1 to C4 of the memory system according to the second embodiment output not only information of Ready or Busy but also information of Pass or Fail indicating whether or not a writing operation has been normally completed. In other words, in the second embodiment, status information includes both of information of Ready or Busy and information of Pass or Fail. The Pass/Fail status information may be supplied to memory controller 2 on the data buses I/O(0) to I/O(7).

The data buses I/O(0) to I/O(7) to be used for transmitting the status information of Ready or Busy and the status information of Pass or Fail for each semiconductor chip (e.g., C1 to C4) are determined in advance. FIG. 8 is a diagram exemplifying a possible combination of status information output from the respective semiconductor chips C1 to C4 on the corresponding data buses I/O(0) to I/O(7). For example, the I/O selection circuit 23 of the semiconductor chip C1 sets the status information of Ready or Busy to be output on the data bus I/O(0), and sets the status information of Pass or Fail to be output on the data bus I/O(1). In the same for the following, the other semiconductor chips C2 to C4 set status information to be output on the corresponding data buses I/O(2) to I/O(7).

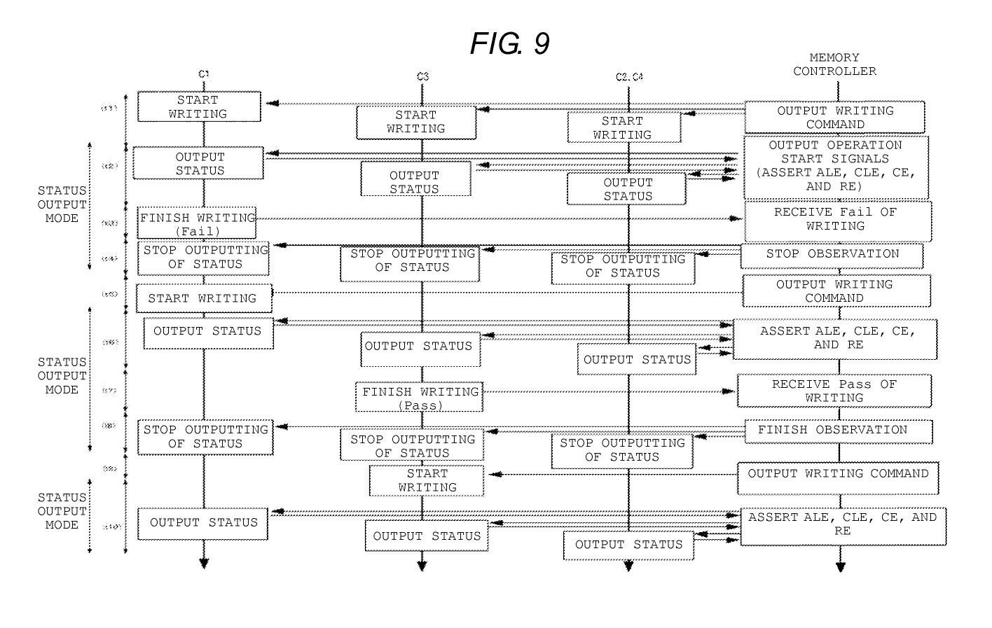

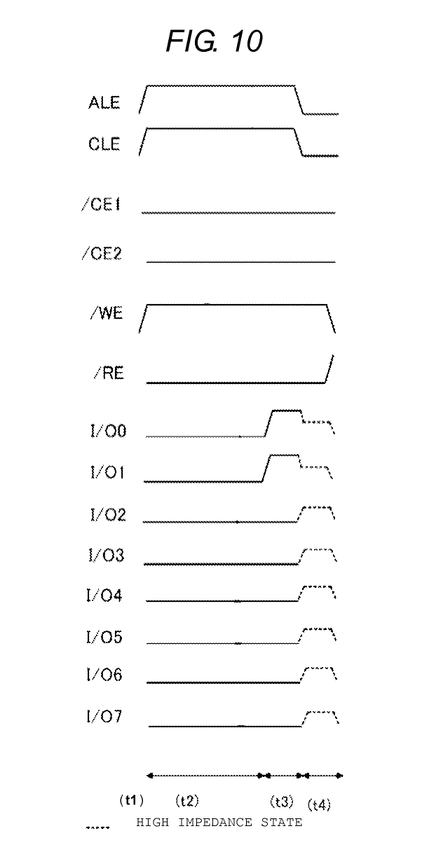

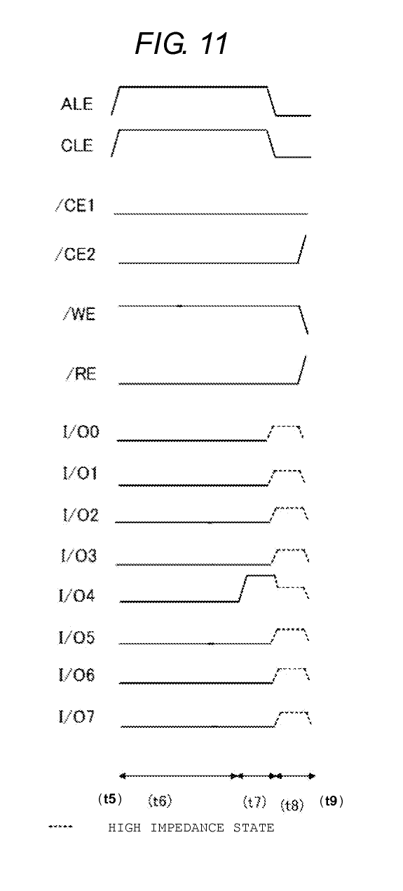

An operation of the memory system 1 according to the second embodiment will be described with reference to FIGS. 9, 10 and 11. FIG. 9 is a diagram illustrating a flow of operations of the semiconductor chips C1 to C4 and the memory controller 2 of the memory system 1 according to the second embodiment. FIGS. 10 and 11 are timing charts illustrating operation after second operation start signals and a status command are input in the memory system 1 according to the second embodiment.

First, the memory controller 2 outputs a writing command to each of the semiconductor chips C1 to C4 (at time t1). A method of outputting the writing command is the same as in the first embodiment, and thus description thereof will be omitted.

Next, as illustrated in FIG. 10, the memory controller outputs second operation start signals (at time t2). Instruction information of the second operation start signals is a signal for instructing that status information of Ready or Busy and status information of Pass or Fail indicating whether or not writing is normally completed be output.

The respective semiconductor chips C1 to C4 output the status information of Ready or Busy and Pass or Fail to the memory controller 2 on the basis of the instruction of the second operation start signals. The second operation start signals are output, for example, when signal ALE is set to an H level, single CLE is set to an H level, signals /CE1 and /CE2 are set to an L level, and signal /RE is set to an L level, and signal /WE is set to an H level. In this embodiment, the L level indicates assertion and the H level indicates non-assertion of the corresponding signal.

Next, as illustrated in FIG. 10, the memory controller 2 asserts the signal lines a1 and a2, and the signal lines b, c and d, so as to output the second operation start signals to the respective semiconductor chips C1 to C4 (at time t2). Each of the semiconductor chips C1 to C4 performs an operation on the basis of the instruction information of the second operation start signals.

As illustrated in FIG. 10, when the semiconductor chip C1 is not performing a write operation, the semiconductor chip C1 outputs a Ready signal to the data bus I/O(0) and also outputs a Pass or Fail signal to the data bus I/O(1) (at time t3). In this case, it is assumed that, the respective semiconductor chips C1 to C4 output a signal with an L level on the corresponding data buses I/O(0) to I/O(7) when a Pass status is output, and output a signal with an H level when a Fail status is output. In this example, the semiconductor chip C1 is assumed to output a signal with an H level to the data bus I/O(1) at (at t3) indicating a Fail status—that is, the write operation was not completed in a normal manner.

When the status information of the semiconductor chip C1 is received, the memory controller 2 sets the data buses I/O(0) to I/O(7) to a high impedance state and stops observing statuses of the semiconductor chips C1 to C4 (at time t4).

Next, the memory controller 2 selects the semiconductor chip C1 again and outputs a writing command thereto (at time t5).

Subsequently, as illustrated in FIG. 11, the memory controller 2 outputs the second operation start signals to each of the semiconductor chips C1 to C4 again (at time t6). The signals ALE, CLE, and /RE are set to an H level, and the signals /CE1, /CE2, and /WE are set to an L level. The respective semiconductor chips C1 to C4 output status information during the operation on the designated data buses I/O(0) to I/O(7) (at time t6).

As illustrated in FIG. 11, when the semiconductor chip C3 finishes an operation, the semiconductor chip C3 outputs a Ready signal to the data bus I/O(4) as status information of the semiconductor chip C3 (at time t7). In addition, the semiconductor chip C3 also outputs a signal with an L level to indicate a Pass signal on the data bus I/O(5) (at time t7).

Next, when the semiconductor chip C3 returns to a Ready status, the memory controller 2 sets output states of the data buses I/O(0) to I/O(7) to a high impedance state and stops observing statuses of the respective semiconductor chips C1 to C4 (at time t8) in the same manner as at time t4.

The memory controller 2 designates, in the same manner as at time t5, the semiconductor chip C3 again and outputs an operation command thereto (at time t9).

The memory controller 2 outputs the second operation start signals to each of the semiconductor chips C1 to C4 again (at time t10).

Subsequently, the memory controller 2 repeatedly performs outputting of an operation command and observing of a status of each of the semiconductor chips C1 to C4 an arbitrary number of times.

Effects of the memory system 1 according to the second embodiment will be described.

In the memory system 1 according to the second embodiment, the semiconductor chips C1 to C4 output a Pass or Fail signal, indicating whether or not a write operation has been normally performed, to the memory controller 2. Accordingly, when the write operation fails, the memory controller 2 can execute a process for performing the next operation on the basis of a corresponding Fail signal—that is, repeat the previously failed write operation, and thus reliability of operations of the semiconductor chips C1 to C4 may be improved.

In addition, although the semiconductor chips C1 to C4 according to the present embodiment output status information of Ready or Busy and status information of Pass or Fail to the memory controller 2, the semiconductor chips C1 to C4 may also be configured to output only the status information of Pass or Fail of writing to the memory controller 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system, comprising:
a first memory chip;
a second memory chip; and
a memory controller connected to the first memory chip and the second memory chip via a plurality of data lines including first and second data lines, and configured to control read and write operations of the first memory chip and the second memory chip, wherein
the first memory chip is configured to output status information to the memory controller via the first data line,
the second memory chip is configured to output status information to the memory controller via the second data line, and
the first and second memory chips are configured to output status information to the memory controller at a same time.

2. The memory system of claim 1, wherein the first memory chip includes a first identification circuit configured to indicate that the status information from the first memory chip is output on the first data line.

3. The memory system of claim 2, wherein the second memory chip includes a second identification circuit configured to indicate that the status information from the second memory chip is output on the second data line.

4. The memory system of claim 1, wherein the memory controller is configured to supply an operation start instruction to cause the first and second memory chips to begin an output of the status information.

5. The memory system of claim 1, wherein the status information from the first memory chip indicates whether a previously instructed writing operation was successfully completed by the first memory chip.

6. The memory system of claim 5, wherein the status information from the second memory chip indicates whether a previously instructed writing operation was successfully completed by the second memory chip.

7. The memory system of claim 1, wherein
the status information from the first memory chip indicates whether the first memory chip is ready to receive an instruction from the memory controller, and
the status information from the second memory chip indicates whether the second memory chip is ready to receive an instruction from the memory controller.

8. The memory system of claim 1, further comprising:
a plurality of signal lines connecting the memory controller to the first and second memory chips, wherein the memory controller is configured to control operations of the first and second memory chips by supplying a signal on each of the signal lines.

9. The memory system of claim 8, wherein the memory controller is configured to supply an operation start instruction to cause the first and second memory chips to begin an output of status information, and the operation start instruction is supplied as signals on two or more of the signal lines.

10. The memory system of claim 1, wherein the memory controller is configured to cause a transfer of data on the plurality of data lines to be stopped based on the status information that is output by the first and second semiconductor chips.

11. The memory system of claim 1, wherein at least one of the first and second memory chips is a NAND-type flash memory chip.

12. The memory system of claim 1, wherein the first and second memory chips are disposed on a same semiconductor chip.

13. The memory system of claim 1, wherein the first and second memory chips are disposed on different semiconductor chips.

14. A memory system, comprising:
a plurality of memory chips; and
a memory controller connected to the plurality of memory chips via a plurality of data lines and configured to control read and write operations of the plurality of memory chips, wherein
each memory chip in the plurality of memory chips is configured to output status information to the memory controller via a respective one of the data lines, and
each memory chip is configured to output status information via the respective one of the data lines at a same time.

15. The memory system of claim 14, wherein each memory chip includes an identification circuit configured to indicate that the status information from the each memory chip is output on the respective one of the data lines.

16. The memory system of claim 14, wherein the memory controller is configured to supply an operation start instruction to cause the plurality of memory chips to begin an output of the status information.

17. The memory system of claim 16, further comprising:
a plurality of signal lines connecting the memory controller to the plurality of memory chips, wherein the memory controller is configured to supply a signal on each signal line in the plurality of signal lines to control operations of the plurality of memory chips, wherein
the operation start instruction is supplied by the memory controller as signals on two or more of the signal lines.

18. The memory system of claim 17, wherein the plurality of memory chips are disposed on two or more semiconductor substrates, and the plurality of signal lines includes at least one chip selection signal line that is connected only to memory chips on a respective one of the semiconductor substrates.

19. A method for controlling a memory system including a plurality of memory chips connected to a memory controller via plurality of data lines, each memory chip configured to output status information via a respective one of the data lines in the plurality of data lines, the method comprising the steps of:
outputting an operation start instruction to the plurality of memory chips to cause each memory chip to output status information via the respective one of the data lines in the plurality of data lines at a same time, the status information from each memory chip respectively including at least an indication of whether the memory chip is ready to receive an instruction to perform at least one of a read operation and a write operation; and
supplying the instruction to perform at least one the read operation and the write operation to a selected memory chip in the plurality of memory chips, the selected memory chip selected according to the status information output from the plurality of memory chips via the plurality of data lines at the same time.

20. The method of claim 19, wherein the operation start instruction is output to the plurality of memory chips as signals supplied on two or more of the signal lines connected to the plurality of memory chips.
